(19) United States
(12) Patent Application Publication
(10) Pub. No.: US 2012/0124593 A1
(43) Pub. Date: May 17, 2012

(54) PROCESS DEVELOPMENT SYSTEM

(76) Inventor: Jason John Walsh, Castleford (GB)

(21) Appl. No.: 13/120,045

(22) PCT Filed: Sep. 16, 2009
(86) PCT No.: PCT/GB2009/002215

§ 371 Date: May 17, 2011

(30) Foreign Application Priority Data
Sep. 19, 2008 (GB) 0817197.7

(51) Int. Cl. G06F 9/46

(52) U.S. Cl. 719/313

(57) ABSTRACT

The provision of a process development system to increase the effectiveness of an organisation. This system includes the use of user access devices to interrogate one or more databases which contain a number of processes linked to at least one activity of the organisation. At least two of the processes are linked in a manner to allow user access from one to the other via a connecting node accessed via an activity diagram and details of the execution of the processes are logged to provide data for development.

The present invention relates to a process development system for a user to plan and develop and store processes on at least one computer means.

Although the following description refers almost exclusively to IT support system processes used in call centre type environments it will be appreciated by persons skilled in the art that the process development system of the current invention can be implemented in other business areas such as banks, hotels and other client or customer facing/support environments, software development processes, software/hardware interface processes, as well as in internal organisation and social process development.

It is known that when people are at work they react to events. Typical examples include:
A customer calls them on the telephone.
A task is assigned to them through a computer application.
A manager sends an email requesting something to be done.
A scheduled task is due, for example a monthly report needs to be produced on the last working day of every month.

People follow a process to handle an event—in order to handle the event a person must execute a number of actions in a specific order. However a problem which is faced is how does the person know what actions to take in order to handle the event correctly? The following are some possible scenarios:

Scene 1: Person knows correct process and executes it—through past experiences the person may know how to handle the event already and steps through the process to a satisfactory conclusion.

Scene 2: Person does not know correct process—what happens when someone does not have the knowledge to handle the event? A number of options are available to them:

Scene 2a: Ask a colleague—they ask a colleague who is available to help on how to handle the event.

Scene 2b: Search a document store—in this scenario there may be no one to help, therefore they search for a documented process which may be in the form of a shared file store.

Scene 2c: Search other information sources—the person searches other information sources for a solution e.g. manuals, web sites etc.

Scene 2d: Delegate the task—finally, if no solution can be found, the person must delegate the task to someone else.

Scenes 2a-d have the problem that valuable time and effort is expended in identifying and/or developing the correct process.

The above examples illustrate scenarios and associated problems that occur within an organisation that has no formal system of communicating and developing processes. Searching for a solution wastes time and effort.

It is therefore an aim of the present invention to provide an improved process development system which overcomes the abovementioned problems.

It is a further aim of the present invention to provide a system implemented through technical apparatus which use improves the communication of business processes throughout an organisation.

It is a yet further aim of the present invention to provide a system that also facilitates continuous reactive and proactive development of the processes, creating an efficient environment within the organisation.

In the first aspect of the invention there is provided an organisation process development system, said system including at least one user access device, a database, a plurality of processes stored in said database, said processes linked to at least one activity of the organisation and said processes represented by one or more activity diagrams, said activity diagrams selectively displayed to the user via the user access device, and wherein at least two processes are linked in a manner to allow user access from one to the other via a connecting node accessed via an activity diagram.

Typically the invention provides a process development system, said system including at least one user application component and at least one process, said at least one process being substantially represented by one or more activity diagrams, at least part of said activity diagram being displayed on one or more units and at least a portion of said activity diagram linked to and/or stored on one or more databases.

In one embodiment the activity diagram is a component of a process that substantially describes the activities of the process in diagrammatic form.

In one embodiment the at least one process is a business process.

In one embodiment the units are video display units. Preferably the units are computer means including a suitable display unit.

In one embodiment the activity diagram is a flowchart and/or workflow diagram and/or the like. Typically the activity diagram includes one or more nodes. Preferably the activity diagram includes at least one start node and at least one terminal node.

In one embodiment the activity diagram includes one or more action nodes, said action nodes providing one or more instructions for execution by the user.

In one embodiment at least a portion of the nodes of the activity diagram are linked by transition lines. Typically, all nodes, with the exception of a start node have at least one incoming transition line. Preferably all nodes with the exception of terminal nodes have at least one outgoing transition line.

In one embodiment the action nodes have one outgoing transition line to another node.

In one embodiment a node with two of more outgoing transition lines is a branch node. Typically the branch node includes at least one branch statement.

In one embodiment at least one guard condition is attached to an outgoing transition line, said guard condition is typically compared to each branch statement in order to determine if the user is to continue across the transition line.

In one embodiment the activity diagram is substantially constructed using the Unified Modelling Language (UML).

In one embodiment one or more outgoing transition lines from a branch node includes a root cause (RC). Typically the root cause is in the form similar to a guard condition whereby the guard condition is associated with a transition line. The root cause object is typically added to a process activity diagram when the reason the process was initiated and/or why the particular transition line from a branch node is chosen is known. A user will typically record a root cause instance by pressing a root cause button and/or imputing said root cause and/or selecting the option from a menu.

Typically a root cause object, such as a button or menu option and or the like is used when the user identifies the reason why a process has been triggered.

In one embodiment the activity diagram includes one or more outcomes. Typically the activity diagram and thus the process include outcomes such as; problem resolved, customer advised of further action, problem re-assigned, request resolved. The outcomes can be used by the process call node to enable the handling and/or analysis of different outcomes.

In one embodiment a first activity diagram includes one or more connecting nodes.

In one embodiment the connecting nodes are activity nodes, said activity nodes link the first activity diagram to at least a second activity diagram. Typically by linking a first activity diagram to at least a second activity diagram two or more processes can be linked. By linking activity diagrams, complex processes can be divided into discreet, simpler activities.

In an alternative embodiment the activity notes are call nodes. Typically call nodes link the current activity diagram note to a second activity diagram for a different event, process and/or activity.

In one embodiment an activity diagram contains at least one connecting node which is a process call node, said process call node providing a link to a second process. Typically, the second process is a substantially independently developed process which can be accessed and re-used by one or more other processes. By linking a first process to a second independent process using a process call node, highly developed and established processes can be incorporated into and/or shared by separate discreet processes under development.

Typically independently developed means a process that has been, or will be, developed at a different time and/or by a different person.

In one embodiment the activity diagram contains at least one connecting node which is a process call node, said process call node providing a link to a second process from a first process.

In one embodiment the second process is a substantially independently developed process which can be accessed during execution of the first process.

In one embodiment the process call node is similar to the activity node, however the process call node links a first process to at least a second independently developed process.

In one embodiment at least one node is linked to one or more databases and/or information stores. Typically said databases are held on one or more computer means.

In one embodiment there are at least two types of users of an organisation process system. Typically the user types are Process Designers and Process Users.

In a preferred embodiment there are three types of users of an organisation process system; Process Designers, Process Administrators and Process Users. Typically Process Designers design and/or develop the process. Typically the Process Users will implement the process following the activity diagram.

In one embodiment the Process Administrators maintain the system and/or administer said system and/or create process systems. Typically this is achieved by maintaining the process and/or event category structure, creating Process Users and assigning process design tasks and/or the like.

In one embodiment the system includes a user application component for each type of user. Typically the Process Administrators use an admin console application component, the Process Designers use a process designer application component and the Process Users use a process navigator application component. Preferably the user application components are accessible from the one or more units.

In one embodiment the process is stored on a database. Typically the database is an SQL database which is accessible by the components of the system.

In one embodiment the at least one process includes a plurality of process components. Typically the process components include any or any combination of the following;
A name (an appropriate name for the process),
A goal (a description of what the process is trying to achieve),
A creator/owner (the person who designed the original version of the process),
Date created (the date when the process was first saved to a database)
An owner (the current owner of the process, typically this person will be responsible for the continued development of the process, using feedback from the process users),
State of process (typically a process can be in one of four states: Assigned, Design, Live or Under Revision),
Version (typically as the process is developed, the version number increases, preferably all previous versions of the process are kept in a database),
Problems (these are reported by the process users and attached to the process they have appeared in),
Category (the processes are organised within categories and typically the process are organised in a tree-like structure similar to a file/folder system. This makes it easier for the Process Designers to locate processes they are working with),
User Roles (typically comparable to the job titles that exist within an organisation. Further typically, a process will be designed to be used by people in substantially the same role, ensuring that they have the right skills to execute actions within the process. One or more user roles can be associated with a process),
Trigger Events (typically a process can be triggered by one or more events. An event is a description of something the user reacts to such as a customer call, or a scheduled event such as the last day of each month. These events are organised within a category similar the processes. The aim of this is to make it easy for the user to locate the event that has just happened, then load and execute the correct process).

In one embodiment a version or process version includes a plurality of components. Typically said components include any or any combination of the following;
version number (typically an incremental number that is increased by one every time a new version is created),
date created,
created by,
date published (date the version was published to end users),
published by,
date regressed,
regressed by,
regression details (typically if the new version is causing substantial problems it can be regressed and the previous version brought back into use. The regression details keep a record of why the version was regressed),
process outcomes (a process version will have one or more outcomes. These are used by process calls that can be designed to handle differing outcomes),
activity diagrams (a process version will contain one or more activity diagrams. This is where the process activities are described in detail. An activity diagram is similar to a work flow diagram, but has a multi-dimensional aspect to it as it can contain other, nested activity diagrams as well as links to other independent processes. Each process version will have one top-level diagram where process execution begins),
execution paths (depending on the complexity and branching of the process version, there will be one or more execution paths. An execution path is a unique sequence of actions that are executed as the user navigates through the process),
process instance (typically logged by the process users when they have completed a particular execution path. This information is then used for reporting purposes),
changes (these are detailed descriptions of changes made from the previous process version).

In one embodiment the changes are detailed descriptions of changes made from the previous process version. They can be either reactive (changes made to solve a problem) or proactive (changes made to increase efficiency of the process).

In an aspect of the invention there is provided a method for implementing an organisation process development system, said system including at least one user access device, a database, a plurality of processes stored in said database, said processes linked to at least one activity of the organisation and said processes represented by one or more activity diagrams, said activity diagrams selectively displayed to the user via the user access device, where at least two processes are linked in a manner to allow user access from one to the other via a connecting node accessed via an activity diagram, said method including the steps;
One or more users logging on to a user access device;
Said user following at least one activity and/or process linked to an activity of an organisation;
Logging the outcomes of a particular activity and/or process being followed; and/or
Logging the process call and/or activity call nodes selected whilst following a process and/or activity to establish the root causes of an action and/or process; wherein
The data logged is used by one or more users to improve the efficiency of one or more processes.

Typically the user access device is console or computer means and/or the like. Further typically and the admin console application is software that interrogates the database.

In one embodiment, once the initial installations are performed, the one or more Process Administrators carry out initial tasks and store the results of said tasks on the database.

Typically these tasks include:

Listing the one or more Process User roles; and/or

Identifying the one or more events a Process User may encounter whilst following the process; and/or

Selecting one or more Process Designers.

In one embodiment once listing the one or more Process User roles and identifying the one or more events a Process User may encounter whilst following the process and selecting the Process Designers has been completed the Process Administrator creates one or more designer accounts.

Typically after selecting the Process Designers the Process Administrator creates their account using the admin console.

In one embodiment the system administrators create one or more events. Typically events are situations, events, actions and the like which occur and trigger the need for a process to be implemented by a Process User. Preferably only events that are linked to a process can be viewed by the Process Users.

In one embodiment the Process Designers create the one or more activity diagrams once the one or more events have been created. Typically when a Process Designer uses their process designer application component they are presented with a list of design tasks assigned by the Process Administrator.

Typically the designer application component is a computer program suitable to draw the one or more activity diagrams.

In one embodiment when the Process Designers are designing the process, said process is in a first design condition.

In one embodiment when the Process Designers have substantially completed the design process said process is moved to a second live condition. Typically moving the design to live allows the Process Users to view and/or use the process.

Typically when the process is moved to a live condition all nodes are checked to establish that branch nodes have more than one outgoing transition line and/or all paths of execution end in a termination node. Additionally all process call nodes and/activity nodes are checked.

Typically live processes are accessed by Process Users through a process navigator application.

In one embodiment once the processes have been moved to a live condition they can be developed further.

Typically the invention provides an organisation process system, said system including at least one user access device, a database, a plurality of processes stored in said database, said processes linked to at least one activity of the organisation and said processes represented by one or more activity diagrams, said activity diagrams selectively displayed to the user via the user access device, and at least two processes are linked in a manner to allow user access from One to the other via a connecting node accessed via an activity diagram wherein said system can be further developed using said at least one user access device after said process is implemented and/or published.

Further typically the invention provides a process development system, said system including at least one user application component and at least one process, said at least one process being substantially represented by one or more activity diagrams, at least part of said activity diagram being displayed on one or more devices and at least a portion of said activity diagram linked to and/or stored on one or more databases wherein said process can be further developed using said at least one user application component after said process is implemented and/or published.

In one embodiment the further development is reactive or proactive. Typically the type of further development depends on any problems encountered when the process is in the live condition or if the further development is scheduled.

For example reactive further development can be initiated by the Process Users when they find errors within the process. Proactive development is typically initiated by the Process Administrators in order to find better ways of working.

In one embodiment the system includes a mechanism to report an error and/or a problem as they are encountered by the Process Users:

Typically the two types of error encountered are ambiguous text in one or more nodes and/or one or more missing options in a branch node.

In one embodiment when a process and/or a linked process is completed a process instance report is generated.

In one embodiment if a process and/or a linked process cannot be completed at least one error report is generated.

Typically the process instance reports and/or the error reports can be used to identify problems in a process. Further typically the reports are used to develop the processes.

In one embodiment the processes can be developed without disrupting the process system.

In one embodiment when an error is reported, the owner of the process and/or the Process Administrator and/or the Process Designer moves the process to a third condition. Typically the third condition is an under revision condition and the process version number increases an integer accordingly.

In one embodiment, once the necessary changes have been made the process is returned to a live condition. Typically the live process retains the increased version number. Preferably previous process versions are retained on the server and/or database so that they can be recovered if necessary and/or to show an audit trail and/or the like.

In one embodiment when a process is moved from an under revision condition to a live condition details of the changes made using a user application component are recorded in a process history file. Typically the process history file is stored on a database.

In one embodiment the proactive further development is initiated to attempt to streamline a process and/or reduces the number of processes initiated or process instances.

In one embodiment the number of root causes and/or activity node and/or call process node instances are listed. Typically the Process Administrator and/or designer can use the lists to implement changes to limit the occurrences of these instances.

In one embodiment the number of root causes and/or activity node and/or call process node instances are listed. Typically the Process Administrator and/or designer can use the lists to streamline the process. By streamlining the process said process becomes more efficient and unnecessary nodes are removed and/or combined.

Typically the number of root causes and/or activity node and/or call process node instances are listed to provide information to improve and/or develop and/or evaluate the process and/or the process system.

In one embodiment the process system can output data relating to the number instances and routes a Process User has taken through an activity diagram. Typically this data is used to further develop and improve the system.

In one embodiment there is provided a method for implementing an organisation process system, said system including at least one user access device, a database, a plurality of processes stored in said database, said processes linked to at least one activity of the organisation and said processes represented by one or more activity diagrams, said activity diagrams selectively displayed to the user via the user access device, and at least two processes are linked in a manner to allow user access from one to the other via a connecting node accessed via an activity diagram, wherein said process can be further developed using said user access device after said process is implemented and/or published, wherein the further development includes the steps;

Recording data relating to Process User entered information, Changing the process from a first live condition to a second under review condition,

Implementing changes whilst process is in the under review condition, and

Returning the process to the live condition.

In one embodiment the processes and data is stored on at least one central database, said database accessible from one or more units.

In one embodiment the user access device a portable device. Typically the portable devices are mobile/cellular phones and/or Blackberries™ and the like.

In one embodiment the user access device has at least one Graphical User Interface (GUI) which can be accessed and/or run in a web-browser application. Typically the process user accesses the system through a web-browser.

Specific embodiments of the invention are now described with reference to the accompanying drawings wherein:

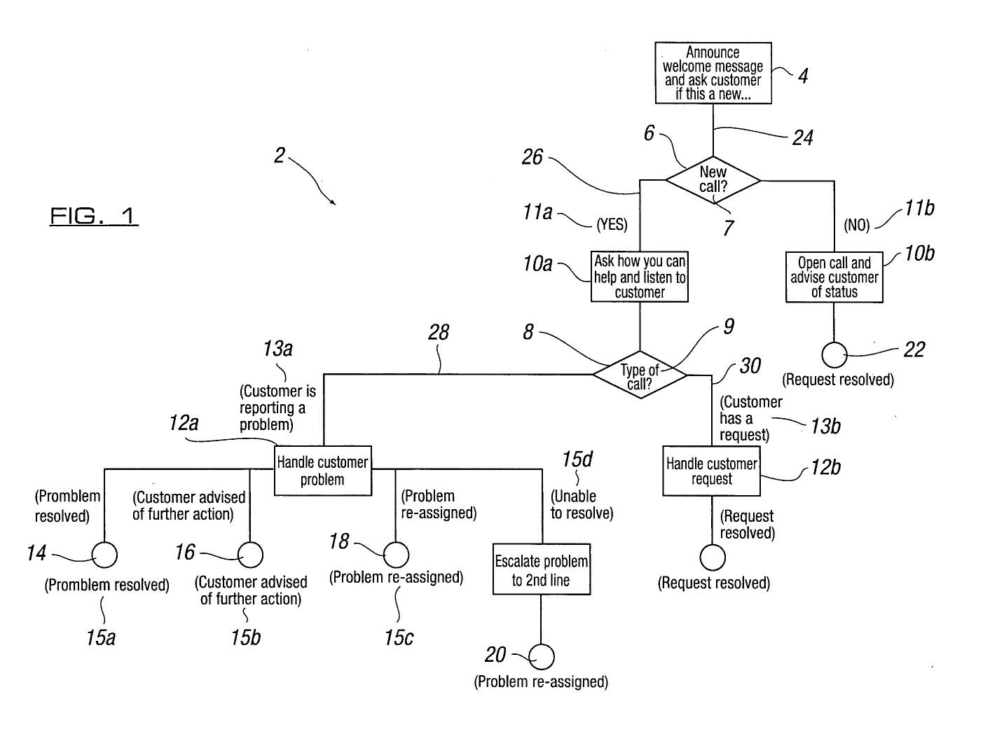

FIG. 1 shows an activity diagram in accordance with one embodiment of the invention.

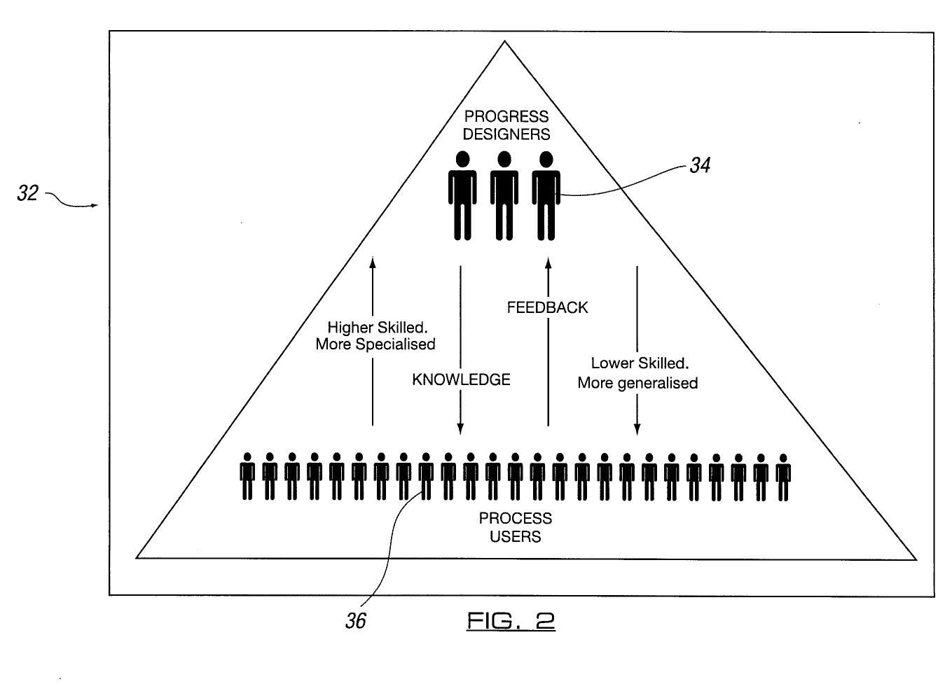

FIG. 2 illustrates the relationship between process designers and process users in accordance with one embodiment of the invention.

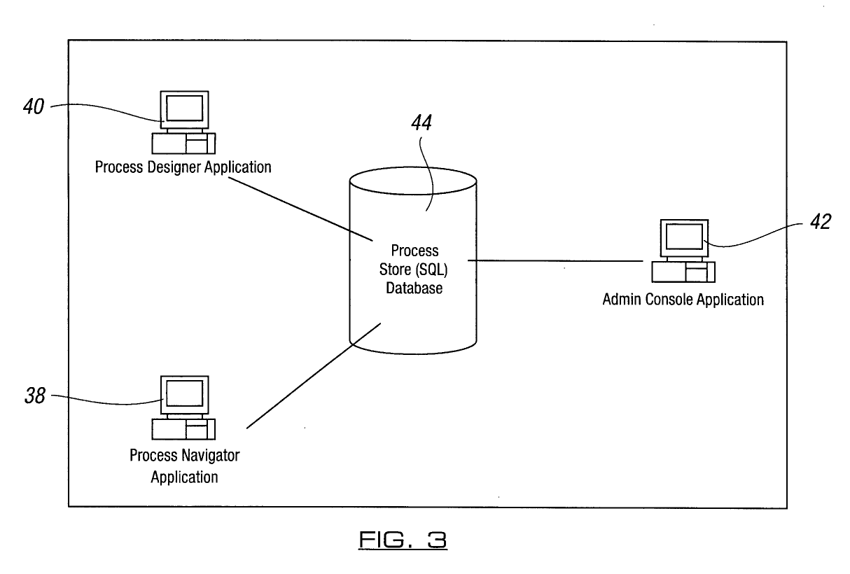

FIG. 3 shows the relationship between the user application components and the database in accordance with one embodiment of the invention.

Turning firstly to FIG. 1, which shows a screen shot of an activity diagram 2, said diagram showing an example of a short process. The activity diagram 2 is constructed from a number of nodes. There are several different types of nodes, including in this example, a start node 4, branch nodes 6, 8, action nodes 10a, 10b, activity nodes 12a, 12b, and terminal nodes 14, 16, 18, 20, 22. A Process User starts the process at the start node 2 which is, in this example, an action-type node to greet the customer. The user then follows the outgoing transition line 24 to a branch node 6. A branch node has at least two outgoing transition lines. The outgoing transition lines of a branch node can also have root cause objects (RCOs) associated with them which identify why/how the particular following node was reached. In this particular embodiment the branch nodes have branch statements 7, 9 and guard conditions 11a-b, 13a-b which correspond to said branch statements 7, 9 respectively. From here it can be seen that if the call is not new the Process User is directed to give the customer the status of their previous call by action node 10b. If this transition line is followed, it is terminated at termination node 22.

Alternatively, if the call is new, transition line 26 is followed. This route leads the Process User through action node 10a to branch node 8. Depending on the customer response either transition line 28 or transition line 30 is followed to an activity node 12a, 12b. These activity nodes or activity call nodes 12a, 12b are more complex than action nodes and are linked to another process activity diagram which describes the instructions in more detail. The potential causes of the terminal nodes 14-20 of the other processes linked to by the activity node 12a are also shown as outcome objects 15a-d. Although in this case the potential terminal nodes are attached to one transition line, potential terminal nodes can be attached to different transition lines emanating from an activity or process call node. This method allows complicated tasks to be split down into a series of simple activity diagrams for the Process User to follow. Ultimately, if transition line 26 is followed the Process User terminates the process at one of the termination nodes 14-20 depending on the outcome 15a-b of the activity node 12a.

Although no process call nodes appear in this example it is appreciated that process call nodes perform in a similar way to activity nodes and link the current activity diagram and process to another, independently developed, activity diagram and/or process.

FIG. 2 shows a diagrammatic representation 32 of the relationship between Process Designers 34 and Process Users 36. Typically the Process Designers 34 possess a higher level skill set and are more specialised employees, hence there are generally fewer Process Designers and more Process Users. Using this process development system the Process Users 36 can still have some input into the design of the processes and the activity diagrams by providing feedback to the Process Designers.

FIG. 3 shows a graphical representation of the relationship between the user application components 38, 40, 42 with the database which stores the processes 44, in this case an SQL database. Typically the process navigator application 38 is a component which is used by the Process User. The Designer and Admin Console applications are used by the Process Designer and Process Administrator respectively. The role of the Process Administrator can vary from example to example but generally there are fewer Process Administrators than Process Designers as they need not be process experts but at least familiar with the process system.

The following information gives specific examples of the intended use/operation of the current invention.

### EXAMPLE

Administrator's Initial Tasks

1. List the User Roles

EasyIT Ltd is an IT support company offering a variety of IT services. It is made up of many business units, each containing personnel with a distinct set of skills.

After consulting with the leaders of the business units, the Process Administrator has identified the following user roles:

Service Desk Technician

2nd Line Technician

Field Service Engineer

Storage Engineer

It is decided the Service Desk Technicians will be the first group to use the system.

2. Identify the Events

After consulting with the Service Desk Manager, the Administrator identifies a single event the users handle:

Customer calls Service Desk

3. Select the Process Designers

People are selected who will design the processes for the first group of users. The designers must have the relevant expertise and skills within a specific field in order to create effective processes. Once the designers have been selected they will need to be trained on using the Process Designer application.

Three people are selected to design the processes for the Service Desk Technicians:

Karen Smith—Service Desk Manager will design the main process to handle customer calls.

John Cooper and Mark Adams—2nd Line Technicians who will design technical processes to be used by the Service Desk.

All three are trained to use the Process Designer application.

4. Create Designer Accounts

After selecting the Process Designers, the Administrator creates their user a/c's using the Admin Console.

The Administrator logs into the Admin Console and opens the User Admin screen as shown in Table 1. The three user a/c's for Karen Smith, John Cooper and Mark Adams are created. Each is assigned Designer status.

5. Create Events & Assign Design Tasks

The Process Administrator is now ready to create the first events using the Admin Console. An event can be linked to an existing process or a new process created and assigned to one of the designers. Only events that are linked to a published process can be viewed by the users.

The Administrator logs into the Admin Console and opens the Event Explorer screen shown in Table 2a. At present the event category only consists of the default category called ‘All Events’.

The Administrator creates another category for the Service Desk events (Table 2b).

The Administrator then creates a new Event named ‘Customer calls Service Desk’. It will be linked to a new process named ‘Handle customer call’ as shown in Table 3a and 3b.

Karen Smith is then assigned the task of designing the ‘Handle customer call’ process.

The Administrator then creates a process category named ‘Service Desk Processes’ and stores the new process in there. As shown in Table 3c

Designing the Process

A designer uses the Process Designer application to create activity diagrams which illustrate the flow of activity during the execution of a process. When the designer logs on, they will be presented with a list of design tasks assigned to them by the Administrator. After selecting one of the design tasks, a blank canvas opens for them to begin drawing the activity diagram. Once the designer begins work on the activity diagram, the process goes into the ‘Design’ state and they become the owner of the process. Our example will illustrate how the diagrams are created.

Karen logs onto the Process Designer application and selects ‘My Processes’ menu option. As shown below in Table 4a.

She selects the process that has been assigned to her and clicks ‘Load Process’ where she is then presented with a blank canvas to draw the diagram.

The first node she draws will be the start node and this is where execution begins. She creates an action as the start node (Table 4b-c).

The next node she adds is a branch. This will create 2 paths of execution depending on whether the customer is logging a new call or is chasing an existing one (Table 5).

V,11-12/2

The first path Karen will draw is when the customer logs a new call. To do this she adds an action node to the branch, and then enters a guard condition for the transition line connecting the 2 nodes as shown in Table 6a-c.

V,13-14/2

Karen then adds another branch to split the path of execution depending on the type of call. The 2 types of call will be:

Customer is reporting a problem

Customer has a request

In order to handle these 2 types of call she will create 2 activity nodes as shown in Table 7. An activity differs from an action because an activity has its own activity diagram. It is distinguished from an action by having underlined text. Activity nodes provide a way of breaking a complex process down into smaller parts, thus providing different levels of detail within the process. The designer has the option to either create a new diagram or use one that already exists.

Karen decides to design the ‘Handle customer problem’ activity first. She selects the node, then selects the Edit>Enter Activity command from the menu bar. She is then presented with a blank canvas on which to draw the activity diagram for ‘Handle customer problem’.

After discussions with experienced Service Desk Technicians, Karen discovers there are 4 main types of problem the customers report:

Problems logging in

Problems using an application

Problems accessing a specific file

Problems accessing a website

The first node Karen creates is a branch which will split the execution path depending on the problem type (Table 8).

Karen decides that she will need 4 processes to handle each type of problem, and the best people to design these more technical, troubleshooting processes would be the two 2nd line technicians. Karen requests the Administrator for 4 processes:

Troubleshoot login problem

Troubleshoot file access problem

Troubleshoot application problem

Troubleshoot web access problem

The Administrator assigns 2 design tasks to each 2nd line technician according to their specific skill set. After the 4 processes had been created and published, the Administrator informs Karen they are now available for use within her process.

Karen logs onto the Process Designer application, and loads the ‘Handle customer call’ process. She then enters the ‘Handle customer problem’ activity and selects the branch she created earlier. She adds a ‘process call’ node to the branch. A process call node is a link to another, published process. This node allows processes owned by different designers to be linked together and also provides a way of re-using common, low-level processes by multiple high-level processes. Without this node the same activity diagrams would have to be created separately within each process, duplicating work done by the designers.

After selecting the process call node, Karen has to enter a guard condition as she would when adding any other node to a branch (Table 9a).

After this the Process Explorer screen opens. Here Karen can select the process she requires as shown in Table 9b.

Karen then adds the other 3 process calls (Table 11). The process calls are distinguished by having blue, underlined text.

You will notice the version number is shown in brackets on the process call nodes. This is because they are links to the current process version. The system has a mechanism of updating these links when a new version is published.

As stated earlier, each process version has one or more outcomes. When Karen attempts to add a node to the process call, she is presented with a list of outcomes (Table 12).

She must select at least one of these outcomes to attach to the transition line coming from the process call. Using this method, designers have a way of creating different execution paths dependant upon the outcome of another process. In this case, Karen will simply add a terminal node for each outcome of each process call.

When adding a terminal to an activity diagram, the designer must select an outcome to attach to the terminal. If the outcome does not exist then a new one can be created. As stated before, each activity diagram has a list of one or more outcomes (Tables 12-14).

In this case, the outcomes for ‘Handle customer problem’ are the same as those contained within the 4 called processes.

Each outcome of a process needs to be attached to one transition line coming out of the process call. This ensures that there is a continuous path of execution from the called process back to the calling process. If there are any outcomes that are missed, the process will not pass verification and cannot be published.

The ‘Handle customer problem’ activity is now complete. Karen selects the Edit>Exit Activity command which takes her back to the top-level activity diagram.

She can now terminate the path of execution taken whenever a customer is reporting a problem (Table 15a). Again she will use a separate terminal for each possible outcome. In the case of the ‘Unable to resolve’ outcome, she adds an action that assigns the problem to the 2nd line support team.

Karen now tackles the other parts of the process in the same fashion. First she completes the ‘Handle customer request’ activity, and then finishes the diagram by providing an execution path for when a customer is chasing an existing call (Table 15b).

At this stage the first version of the process is complete but it is still in the ‘Design’ state. Karen now publishes the process which changes the state from ‘Design’ to ‘Live’ and makes the process available to the users. During publication the process goes through a number of checks. These include:

Branch nodes are checked to ensure they have more than one outgoing transition line.

All paths of execution must be terminated.

All terminals within a process call/activity must be handled by the calling node.

Karen selects Process>Publish Process menu command. After a short while she receives the following message shown in table 16:

The process is now available to the Service Desk Technicians.

Accessing the Processes

Once processes have been created and made live, they will be available to the users through the Process Navigator application. Before this however, the user accounts will need to be created by the Administrator and the Navigator application installed on the relevant machines.

The Process Navigator is a simple tool to use and will require little training, our example will demonstrate how an end user will load the correct process and step through it to a satisfactory conclusion.

For example, after installation of the Process Navigator application on the Service Desk computers, the Administrator creates the user a/c's for the desk technicians (Table 17).

Sam Taylor is a Service Desk Technician who has just received her login details and is ready to begin using the system. She opens the Process Navigator and logs in. Sam only deals with one event, when a customer calls her on the service desk. Now that the attached process is live she will be able to see this event in the initial Navigator screen (Table 18). V,29-30/2

Sam receives a call from a customer. She selects the ‘Customer calls Service Desk’ event and clicks the ‘Load Process’ button. The first action is then displayed in the Navigator (Table 18).

Sam executes the action and moves onto the next node by clicking the right arrow button. The next node is a branch. Sam is presented with a question and 2 options to choose from (Table 18b).

The customer has stated that they are logging a new call, so Sam selects the ‘Yes’ option, then clicks the right arrow button to continue. She is then presented with the next action (Table 18c).

If Sam had chosen the wrong option, she can always go back to the previous node by clicking the left arrow button.

Sam asks the customer how she can help and the customer replies

“I'm trying to login to my machine and it wont let me!”

Sam clicks the right arrow button and is presented with the following (Table 18d).

Sam selects the ‘Customer is reporting a problem’ option and clicks the right arrow again. Here Sam is presented with an activity node, as indicated by the blue text. When an activity or process call is been viewed, the down arrow button is enabled. This allows a user to enter the activity or process and view the detailed actions (Table 18e).

Sam clicks the down arrow and enters the ‘Handle customer problem’ activity. She is then presented with a branch with 4 options (Table 18f). If Sam enters an activity in error, she can exit the activity by clicking the up arrow.

She selects the ‘Customer cannot login’ option and clicks the right arrow.

She enters the ‘Troubleshoot login problem’ by clicking the down arrow (Table 18g) and is presented with an action node (Table 18h).

The customer has already stated she is getting an error when logging in. Sam clicks the right arrow and presented with a further branch node (Table 18i).

Sam clicks ‘Yes’ option then clicks right arrow and is presented with a further activity node (Table 18j).

Sam enters the next activity and the navigator displays another action node (Table 18k).

Sam asks the customer for the error message showing on screen. The customer replies

“Your account has been locked”

Sam clicks right arrow to display a branch node (Table 18l).

Sam selects ‘Account is locked’ option and clicks right arrow to display the activity node shown in Table 18m.

Sam has unlocked accounts before and does not need to enter the activity to see the detailed actions. She unlocks the account then clicks the right arrow to display an action node (Table 18n).

The customer attempts to logon but states she is still getting an error. Sam clicks the right arrow and is presented with a further branch node (Table 18o).

Sam asks the customer if they are getting same error. The customer replies “No—its now saying I've entered an invalid username or password.”

Sam selects the 2nd option and clicks right arrow to reveal a yet further branch node (Table 18p).

Sam selects the first option and clicks right arrow to reveal an activity node (Table 18q).

Sam enters the activity by clicking the down arrow to show an action node (Table 18r).

The customer checks the caps lock function and notices it is not disabled. Sam clicks the right arrow (Table 18s).

Sam selects ‘No’ then clicks right arrow to show another action node (Table 18t).

The customer disables the caps lock function and logs in successfully. Sam clicks the right arrow to display a branch node as shown in Table 18u.

Sam selects ‘Yes’ option and clicks right arrow. Here she is presented with the ‘End of Process’ message (Table 18v).

At the end of a successful process execution, the green tick button becomes enabled. When this button is clicked, a process instance is recorded in the database. This information is then used for reporting and proactive process development. We will look more into this later in the document.

Sam clicks the green tick button and is then returned to the events screen.

Process Development

In this section we look at how processes evolve over time once they have been published. We divide process development into areas: reactive and proactive. Reactive development is initiated by the process users when they find errors within the process. Proactive development is initiated by the Administrators in order to find better ways of working.

1. Reactive Development

Here we will look at how errors within a process are reported, and how the owner of the process reacts and changes the process in order to ensure the error does not re-occur in future instances.

Reporting an Error:

The initial versions of any process may contain errors that were overlooked by the designer. As the user navigates the process, they may come across these errors which will bring process execution to a halt. The system has incorporated a mechanism to enable the process users to report any errors they come across while executing the process. These errors are then attached to the process, and the process owner is alerted the next time they login.

Two types of error a user may encounter are:

Ambiguous text—the user cannot execute an action because they don't fully understand the action text or they are confused by the question being asked when viewing a branch node.

Missing option—the user has navigated to a branch node but cannot see a relevant option to choose.

If a user comes across an error, they can click the ‘Report Problem’ button which is indicated by a white exclamation mark on a red background. They will then be presented with a form to enter the relevant details of the problem. This information will be used by the process owner to edit the process and remove the error.

For example, Graham has just started as a Service Desk Technician and has been successfully using the Process Navigator to handle a number of calls.

He receives a call from a customer requesting her login details. He loads the ‘Handle customer call’ process and navigates to the ‘Handle customer request’ activity (Table 19a).

He enters the activity, and selects the ‘New customer requests login details’ option show in Table 19b.

He clicks the right arrow button and is presented with the following action (Table 19c):

At this point Graham becomes stuck. He does not know how to access the login details to inform the customer. Graham transfers the customer to a more experienced colleague then decides to report the problem.

He clicks the exclamation button and is presented with the ‘Report Problem’ form. He selects the relevant option and enters the problem he encountered during execution of the process (Table 19d).

2. Revising a Process:

When a problem is attached to a process, the owner will need to edit the activity diagram so that the problem does not re-occur in future instances. In order to edit the process, it needs to be placed in the ‘Under Revision’ state. When a process is put ‘Under Revision’ the current activity diagram, which we will call version 1, is copied and made into version 2. The designer may now edit version 2 while version 1 is still accessible by the users.

Once the designer is happy with the changes they have made, the process can be published again. The state is changed back to Live, and the users now access the updated version 2. Version 1 remains in the database in case the designer needs to revert back to it if other problems arise through the change.

When publishing a process again, the system will ask for details of the changes made. This way a full history of the process changes are kept within the database. If a process ever needs to be regressed to a previous version because the changes are causing problems, the reasons for this regression are also stored within the process history. This prevents any design mistakes being repeated in future versions of the process.

It is always a good idea for the designer to view the history of a process before making any changes to it, especially it they were not the original owner. This way any errors that were previously made in the design of the process can be avoided.

For example, Karen logs on to the Process Designer application and sees that there is a problem attached to the ‘Handle customer call’ process she owns. The problem is associated with an action node within the ‘Handle customer request’ activity as shown in Tables 19e(1)-Table19e(3).

She loads the process and selects Process>View Problems.

Karen selects the problem and clicks ‘View Details’.

Karen decides that to stop this problem re-occurring, she will change this action into an activity in order to describe the action in more detail.

Before making any changes she must change the process state to ‘Under Revision’. She does this by selecting the Process>Revise Process menu command. She is now able to edit the process.

She adds an activity with the same name as the action, and then removes the action and terminal nodes (Table 19f).

She enters the activity and adds the more detailed action steps (Table 19g).

She then terminates the new activity (Table 19h).

Karen records the change in the problem details form shown in Table 19i.

Karen then publishes the new version by selecting the Process>Publish Process menu command. and is presented with a verification message (Table 19j).

The process has now returned to the ‘Live’ state and the new version is available to the users.

Days later, Graham receives another call from a customer requesting their login details. He loads the ‘Handle customer call’ process and navigates to the ‘Handle customer request’ activity (Table 19k).

He enters the activity, and selects the ‘New customer requests login details’ option (Table 19l).

He clicks the right arrow button and this time he is presented with an activity not an action as shown in table 19m.

He now has the ability to click on the down arrow to view more detailed action steps (Table 19n to 19q).

Graham can now log a successful process instance.

2. Proactive Development

For the first few weeks after the system has been implemented, reactive development of the processes will be the main activity of the designers as they receive feedback from the process users. After a while the processes begin to take shape and work well for the normal day to day activities of the users.

At this point the Administrator should start to think of strategies for proactive development of the processes in order to cut costs and increase efficiency of the organisation as a whole. The database should now contain information on the process instances that have been executed by the users, and the Administrator will be able to produce reports on these and target the most prolific and costly processes for proactive development.

We can identify 2 goals for proactive development:

Reduction of process instances

Streamlining of processes

Reducing Process Instances:

As seen in the earlier example, when the designer is adding a guard condition to a transition line emitting from a branch node, they have the option of adding a Root Cause Object (the RCO button). These objects are added when there is a point within the process that the reason why the process was initiated is known.

To illustrate, let's look at the ‘Troubleshoot “WinWord.exe has generated errors” problem’ activity contained within the ‘Troubleshoot file access problem’ process (Table 20a).

If the user goes down the path of the transition line with the guard condition ‘Less than 10 MB’, the root cause of the problem would be that the customer has run out of disk space.

When the transition line is selected, the designer can add a Root Cause object to it by selecting New>Root Cause. A list of existing Root Cause objects are displayed along with an option to create a new one. The Root Cause object is displayed on the transition line between 2 asterisks (Tables 20b-c).

Our example will illustrate a powerful reporting tool that can be used to list the most costly root cause objects, and thus initiate changes to limit these and reduce the total number of process instances.

For example, it has been 3 months since the system has been implemented by the Service Desk. Efficiency has already increased as technicians now have instant access to the knowledge they require to handle all customer calls. The Administrator now decides it is time for some proactive development.

The Administrator runs the Root Cause Analysis report on the ‘Handle customer call’ process and views the following information, shown in Table 21:

Here the Administrator sees that 633 instances were caused by the customer running out of disk space.

The Administrator passes the report to Roger Wood, the head of the 2nd line team, with a request for him to develop ideas to reduce the total number of instances caused by low disk space. In conjunction with his team members Roger comes up with 2 initiatives:

Enhance the login script to remove any temporary files on the customers machine

Create an archiving process for the customer

After consulting with the client, the Administrator agrees to these initiatives which Roger's team then implements. The login script is changed and tested, and an archiving process is developed which is then published on the client's intranet site.

A month later, the Administrator checks what impact the changes have made on the number of process instances caused by low disk space (Table 22a).

The graph clearly shows a drop in the number of instances after the changes have been implemented.

The Administrator sends the report to the client, who is most impressed with the company's proactive approach in improving customer service.

Streamlining Processes

This strategy of proactive development looks at ways of reducing the total number of actions that are executed by the user when implementing a process. One way of doing this is by automating several human actions. Our example will illustrate how the system can produce reports that identify processes and activities that have a large number of actions and how automation can reduce the total number of actions, speeding up the process and making it more efficient.

For example, EasyIT Ltd have hired a scripting expert who's job will be to write scripts that automate several actions currently executed by the technicians.

The Administrator runs the Activity Report on Event-Level Processes (Table 23).

The Administrator then opens the details for ‘Handle customer call’ process. This displays the individual Execution Paths that the process users have taken when implementing the process and sorts them by the most prolific (Table 24).

The Administrator goes down the list and finds one that could be suitable for automation.

The programmer agrees that this execution path could be reduced by automating the ‘Reset proxy settings’ activity.

He produces a script and locates it in an area where the technicians can access it. He informs Mark Adams (the process owner) who then produces a new version of the ‘Troubleshoot web access problem’ process (Table 25).

Mark records this as a proactive change (Table 26).

A month later the Administrator checks the new execution path (Table 27).

Although the new execution path is still high up on the list, the total number of actions has been more than halved.

5. Conclusion

We will conclude by reviewing the initial goals of the system and look at the example case to see how the system has achieved those goals. We will then summarise the benefits the system can bring to any organisation.

5.1 Improving Communication of Business Processes

Before the system was implemented, EasyIT had an informal way of transferring knowledge from person to person. If a technician did not know how to handle a call they would simply ask someone who did. Problems occurred when the more experienced technicians were unavailable to assist. The organisation was also exposed to knowledge leaving the company altogether if someone left. Although the Service Desk had a small document store containing business processes, choosing the right process was a problem for the technicians. The documents were rarely updated and so were mostly out of date. If any changes were made to these documents, no histories of the changes were kept and so any errors made in the past could be repeated in the future.

Shortly after implementing the system, the technicians had a more structured way of handling the customer calls. Finding the right process was easy because in this case there was only one event. It would be just as easy to locate the right process in a more complex working environment as the users simply select the event that is happening at the time. Knowledge is now transferred from experts in specific domains to the people who really need it. A full history of all the process changes is stored in the database enabling the designers to learn from past mistakes.

5.2 Facilitating Reactive Process Development

Originally EasyIT had a limited form of reactive development. Processes came from other business units and the technicians had to follow them the best they could. The only feedback they had was to inform the desk manager of any problems they encountered, who would then try to get a resolution from the appropriate business unit. If the documentation was not updated, another person would experience the same problem later on and approach the desk manager for a resolution again.

With the system in place, the technicians have the power to report any problems with the processes they use. The information is reported to the right people, who can use it to create a better process and prevent future occurrences of the same problem. The administrators can chase up any problems that have been unresolved for a lengthy amount of time.

5.3 Facilitating Proactive Process Development

EasyIT did little in the way of proactive development before the system was implemented. Occasionally members of other business units would visit the service desk, and listen to ideas from the technicians. The limited document store was rarely studied by anyone to see if improvements could be made. Without any data coming from the technicians, no one knew which processes were the most prolific and costly.

With the system in place, information is available to the administrators who can then initiate activities to improve the most costly processes. In our example this was done by producing a script to automate a series of manual actions. Other methods could include developing more efficient computer applications, designing better tools or looking at a better division of labour within the process. EasyIT now has a better working environment in which new ideas are encouraged.

5.4 Summary

In a nutshell, this system is all about increasing individual productivity within an organisation. By providing clear, unambiguous instructions to the user base, work is carried out quickly and efficiently. As one user encounters a problem, the problem is fixed and never encountered again by other users, removing the wasteful cost of searching for a solution to a problem that has already being found. As the designers produce more processes, repetitive work is transferred from the higher skilled staff to the more generically skilled staff, freeing up time for more proactive work. This has the effect of increasing productivity of both designers and users.

After the system is implemented within an organisation, everyone involved will benefit from each others experiences and knowledge, creating a truly cohesive and dynamic environment in which to work.

1. An organisation process development system including at least one user access device, a database, a plurality of processes stored in said database, said processes linked to at least one activity of the organisation and said processes represented by one or more activity diagrams, said activity diagrams selectively displayed to the user via the user access device, wherein at least two processes are linked in a manner to allow user access from one to the other via a connecting node accessed via an activity diagram.

2. A system according to claim 1 wherein the activity diagram contains at least one connecting node which is a process call node, said process call node providing a link to a second process from a first process.

3. A system according to claim 2 wherein the second process is a substantially independently developed process which can be accessed during execution of the first process.

4. a system according to claim 1 wherein there are at lease two types of user of said system.

5. A system according to claim 4 wherein the users include Process Designers, Process Administrators and Process Users.

6. A system according to claim 1 wherein the processes include a plurality of process components.

7. A system according to claim 1 wherein when a process and/or a linked process is completed a process instance report is generated.

8. A system according to claim 7 wherein if a process and/or a linked process cannot be completed at least one error report is generated.

9. A system according to claim 8 wherein the process instance reports and/or the error reports can be used to identify problems in a process.

10. A system according to claim 9 wherein the reports are used to develop the processes.

11. A system according to claim 10 wherein when the processes can be developed without disrupting the process system. Preliminary Amendment

12. A system according to claim 11 wherein a process has a number of versions and when the latest version is under development the previous version is available for use.

13. A system according to claim 11 wherein each process includes a number of conditions.

14. A system according to claim 13 wherein when a process is under development it is in a Under Revision condition and when it is available for use it is in a Live condition.

15. A method of implementing an organisation process development system, said system including at least one user access device, a database, a plurality of processes stored in said database, said processes linked to at least one activity of the organisation and said processes represented by one or more activity diagrams, said activity diagrams selectively displayed to the user via the user access device, where at least two processes are linked in a manner to allow user access from one to the other via a connecting node accessed via an activity diagram, said method including the steps;
One or more users logging on to a user access device;
Said user following at least one activity and/or process linked to an activity of an organisation;
Logging the outcomes of a particular activity and/or process being followed; and/or
Logging the process call and/or activity call nodes selected whilst following a process and/or activity to establish the root causes of an action and/or process; wherein
The data logged is used by one or more users to improve the efficiency of one or more processes.

16. An organisation process system, said system including at least one user access device, a database, a plurality of processes stored in said database, said processes linked to at least one activity of the organisation and said processes represented by one or more activity diagrams, said activity diagrams selectively displayed to the user via the user access device, and at least two processes are linked in a manner to allow user access from one to the other via a connecting node accessed via an activity diagram wherein said system can be further developed using said at least one user access device after said process is implemented and/or published.
